(19) United States
(12) Patent Application Publication
(10) Pub. No.: US 2003/0220914 A1
(43) Pub. Date: Nov. 27, 2003

(54) Method for managing data in a network

(75) Inventors: Valerio De Angelis, Goleta, CA (US); Matthew Elmer Smith, Bakersfield, CA (US); Jonathan David Sullivan, Burlington, VT (US)

Correspondence Address: WHITE & CASE LLP, PATENT DEPARTMENT, 1155 AVENUE OF THE AMERICAS, NEW YORK, NY, 10036, US

(73) Assignee: MINDFLASH TECHNOLOGIES, INC.

(21) Appl. No.: 10/160,684

(22) Filed: May 23, 2002

(51) Int. Cl. G06F 7/00

(52) U.S. Cl. 707/3

(57) ABSTRACT

A data transfer and management process includes transferring an XML string representing a tree structure of a folder from a network server (12) to a client station (14A) in response to a request at the client station for accessing the folder. The transferred XML string includes the information regarding all subfolders and the names of all files in the folder, but not the content of the files in the folder. At the client station (14A), the XML string is parsed on demand to generate JavaScript codes to present the descendents of a folder in response to a request for accessing the folder, which may be a root folder or a branch folder. In response to a request of accessing a file in the folder, the client station (14A) initiates a process for transferring the content of the file from the network server (12).

### FIELD OF THE INVENTION

The present invention relates, in general, to network documentation and specifically to the transfer and management of documents in a network.

### BACKGROUND OF THE INVENTION

Document transfer is one of the most widely used applications in both Internet and Intranet environments. A process for transferring a document from a network server to a client station typically includes the client station establishing a connection with the server, searching for the document on the server, transferring the document from the server to the client station, and terminating the connection between the client station and the server. This process is performed each time the client station seeks to access a document that is not already present on the client station.

Such a document transfer process is resource inefficient and time consuming. Specifically, establishing the connection between the client station and the server creates a heavy overhead in the document transfer process. In order to reduce the overhead, the client station may seek to transfer multiple documents, e.g., a collection of many documents related to a subject, each time the client station is connected to the server. In this approach, the average overhead of establishing a network connection for transferring each document in the collection is reduced. However, transferring the whole collection of documents may require a high data transfer rate and/or a long data transfer period, thereby adversely affecting the cost of the data transfer operation. In addition, a long data transfer period is susceptible to connection interruptions between the client station and the server. Also, the transferred collection of documents may take a large amount of memory space on the client station, thereby decreasing the operation efficiency of the client station.

Accordingly, it would be advantageous to have a method for efficiently transferring and managing documents in a network environment. It is also advantageous for the method to be able to reduce the data transfer operation overhead and increase the data transfer efficiency. It is further advantageous for the method to have a high data transfer reliability. In addition, it is advantageous for the method to efficiently manage the document and provide easy and fast access to the document. It would be of further advantage for the method to efficiently utilize memory space.

### SUMMARY OF THE INVENTION

An advantage of the present invention is providing an efficient process for transferring and managing data in a network. Specific advantages of the data transfer and management process in accordance with the present invention include improved data transfer efficiency and improved data transfer reliability. Additional advantages of the data transfer and management process in accordance with the present invention include providing easy and fast access of the document, as well as efficient usage of memory space.

A data transfer process in accordance with the present invention includes transferring a string, e.g., an Extensible Markup Language (XML) string, representing a tree structure of a folder on a network server to a client station in response to a request at the client station for accessing the folder. The transferred string includes information regarding all the subfolders and the names of all the files in the folder, but not the content of the files in the folder. By transferring only the string related to the tree structure of the folder, the data transfer process is fast and network resource efficient. At the client station, the string is parsed on demand to generate a code, e.g., a JavaScript code, to present the direct descendents of a folder, which may be either a root folder or a branch subfolder, in response to a request for accessing the folder. Parsing only portions of the string to generate the code presenting only the direct descendents of the folder significantly reduces the computing time and resource usage. In response to a request to access a file in the folder, the client station initiates a process for transferring the content of the file from the network server.

### BRIEF DESCRIPTION OF THE DRAWINGS

FIG. 1 illustrates a network system through which data is transferred in accordance with the present invention;

FIG. 2 illustrates a data directory to be transferred in a network system in accordance with the present invention;

FIG. 3 illustrates a process for transferring and managing data in accordance with the present invention; and

FIG. 4 illustrates a presentation of a folder in the data directory in accordance with the present invention.

### DETAILED DESCRIPTION OF VARIOUS EMBODIMENTS

Various embodiments of the present invention are described hereinafter with reference to the figures. It should be noted that elements of similar structures or functions are represented by like reference numerals throughout the figures. It should also be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and can be practiced in any other embodiments of the present invention.

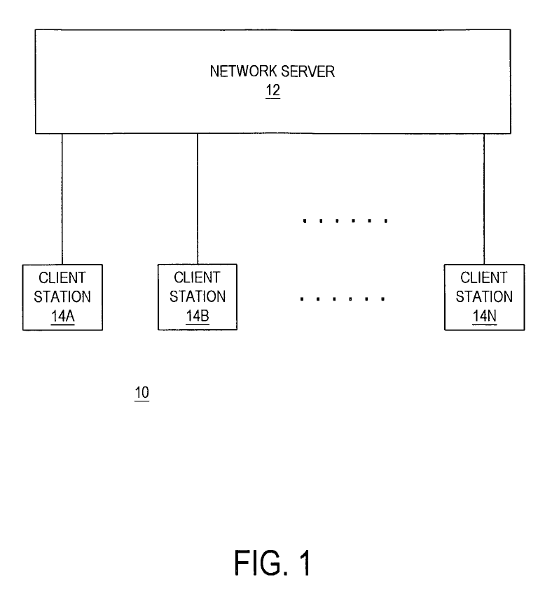

FIG. 1 illustrates a network system 10, through which a data transfer process transfers data in accordance with the present invention. Network system 10 can be an Internet system, an Intranet system, a Local Area Network (LAN) system, an Ethernet system, a wireless network system, etc.

Network system 10 includes a network server 12 and a plurality of client stations 14A, 14B, . . . , 14N. Each of client stations 14A-14N may be a personal computer, a workstation, a personal digital assistant (PDA), or any other kind of data processing and storage device. Typically, each of client stations 14A-14N includes a readable storage medium accessible by a processor, e.g., a microprocessor (μP), a central processing unit (CPU), a digital signal processor (DSP), etc. The readable medium includes a program routine that, when executed by the processor, performs a data transfer and management process in accordance with the present invention. Network server 12 includes data that is accessible by users through client stations 14A-14N. In accordance with one aspect of the present invention, the data transmission between network server 12 and client stations 14A-14N is through a wired signal transmission medium, e.g., telephone lines, analog signal cables, digital signal cables, serial data transmission lines, parallel data transmission lines, optical fibers, etc. In accordance with another aspect of the present invention, the data transmission between network server 12 and client stations 14A-14N is through a wireless signal transmission medium, e.g., radio wave signal transmission, microwave signal transmission, infrared signal transmission, etc. Furthermore, network server 12 can transfer data with some client stations, e.g., client station 14A, through a wired transmission medium and with other client stations, e.g., client station 14B, through a wireless transmission medium. In accordance with the present invention, network server 12 is capable of communicating with one or more client stations simultaneously. In addition, one client station, e.g., client station 14A, may be able to communicate with another client station, e.g., client station 14B, either directly or through network server 12.

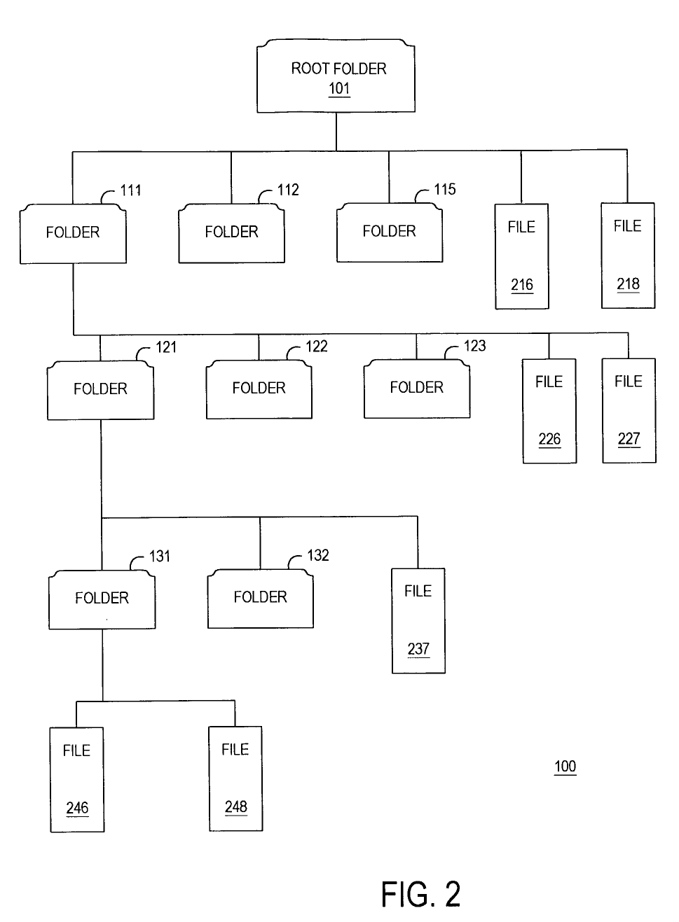

FIG. 2 illustrates a directory 100 of data to be transferred through network system 10 of FIG. 1 in accordance with the present invention. In accordance with an embodiment of the present invention, directory 100 of data is stored on network server 12 shown in FIG. 1. A user on a client station, e.g., client station 14A shown in FIG. 1, seeks to access the data in directory 100.

Directory 100 has a tree structure comprised of folders and files. A root folder 101 includes a plurality of subfolders 111, 112, and 115, and a plurality of files 216 and 218. Each of subfolders 111, 112, and 115 may include subfolders and/or files therein. One or more of subfolders 111, 112, and 115 may also be empty. Subfolders 111, 112, and 115 function as roots with respect to the subfolders and/or files therein, and are therefore also referred to as subroot folders, branch folders, or simply folders in directory 100. Files 216 and 218 are referred to as leaves under folder 101 of directory 100.

By way of example, FIG. 2 shows subfolder 111 including subfolders 121, 122, and 123, and files 226 and 227. Also by way of example, FIG. 2 shows subfolder 121, which is also referred to as a subroot folder or a branch folder under branch folder 111, that includes subfolders 131 and 132, and a file 237. Furthermore, FIG. 2 shows subfolder 131, which is also referred to as a subroot folder or a branch folder under branch folder 121, that includes files 246 and 248. Like files 216 and 218, files 226, 227, 237, 246, and 248 are also referred to as leaves in directory 100. A file in directory 100, e.g., any of files 216, 218, 226, 227, 237, 246, and 248, includes a filename that represents the corresponding file in directory 100. A file in directory 100 can be a file of any type such as, for example, a text file, a Microsoft Word file, a Microsoft Excel file, a Microsoft PowerPoint file, a Hyper Text Markup Language (HTML) file, a Dream Weaver file, a Frame Maker file, a source code file, an application file, etc.

It should be understood that the structure of data directory 100 is not limited to what is described herein and shown in FIG. 2. A folder or subfolder in directory 100 can include any number of subfolders and any number of files. A folder or subfolder can also be an empty folder in the sense that it does not include any subfolder or file. In addition, directory 100 is not limited to having a tree structure with a tree depth of 4 as shown in FIG. 2. Directory 100 can have any tree depth.

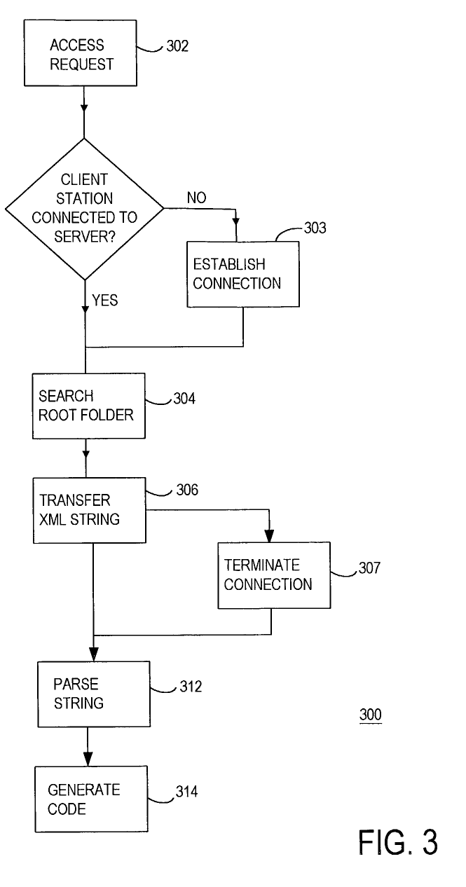

FIG. 3 is a block diagram illustrating a process 300 for transferring and managing data in accordance with the present invention. By way of example, a user on a client station, e.g., client station 14A shown in FIG. 1, uses data transferring and management process 300 for accessing data in directory 100 shown in FIG. 2 and stored in network 12 shown in FIG. 1. It should be noted that data transfer and management process 300 can be executed on any one of client stations 14A-14N in network system 10. In addition, data transfer process 300 can also be executed on network server 12 to transfer data from another network server (not shown in FIG. 1) to network server 10 in network system 10. In such a process, network server 12 functions as a client station in network system 10.

In a first step 302, a user at client station 14A makes a request for accessing directory 100. The request may be made in the form of a search request that has a phrase related to directory 100 as a keyword. For example, the phrase may be related to the title or subject matter of directory 100, the name of root folder 101, the name of any branch folder in directory 100, or the name of any file in directory 100. The phrase may also be related to the author of directory 100, the date of creation or revision of directory 100, or the characteristics of the data in directory 100. If client station 14A is not already connected to network server 12, client station 14A establishes a connection with network server 12 in response to the user request in a step 303.

In a step 304, client station 14A searches the memory space in network server 12 for directory 100. Specifically, client station 14A searches for root folder 101 in the tree structure of directory 100. In a step 306, the tree structure of directory 100 is transmitted from network server 12 to client station 14A. In accordance with one embodiment of the present invention, the tree structure of directory 100 is transferred from network server 12 to client station 14A in the form of an Extensible Markup Language (XML) string. The tree structure includes the information regarding the relation between root folder 101 and all branch folders and leaves in directory 100. It also includes a list of the names of all the files in the various folders in directory 100.

In accordance with an embodiment of the present invention, the contents of the files in directory 100 are not transferred from network server 12 to client station 14A during data transmission step 306. Generally, the XML string regarding the tree structure of directory 100 is relatively small in size, typically no greater than several kilobytes. On the other hand, the size of a file in directory 100 may easily exceed several megabytes or even gigabytes. Transferring only the tree structure of directory 100, and not the contents of the files therein, improves the time and resource efficiency of data transmission step 306. It also reduces the transmission time and improves the data transfer reliability of step 306. The transferred XML string is stored in a memory space on client station 14A.

After transferring the tree structure of directory 100 from network server 12 to client station 14A, the connection between client station 14A and network server 12 is terminated in a step 307. This will free up the connection capacity in network server 12 and improve the operation efficiency of network system 10. However, step 307 of terminating the connection between network server 12 and client station 14A is optional. The connection between network server 12 and client station 14A can be maintained, for example, in response to client station 14A seeking to access additional data at network server 12.

In a step 312, the user on client station 14A seeks to access a folder, e.g., branch folder 111, in directory 100. By way of example, this can be achieved by first clicking a button representing root folder 101 of directory 100 and then clicking a button representing branch folder 111.

In response to the user clicking root folder 101, client station 14A parses the portion of the XML string corresponding to root folder 101, and the folders and the file names that are directly below root folder 101. Specifically, client station 14A parses the portion of the XML string corresponding to root folder 101, branch folders 111, 112, and 115, and files 216 and 218 in data directory 100. As shown in FIG. 2, branch folders 111, 112, and 115, and files 216 and 218 are direct descendents of root folder 101.

In response to the user clicking the button representing branch folder 111, client station 14A parses the portion of the XML string corresponding to branch folder 111, and the branch folders and file names that are direct descendents of branch folder 111 in the tree structure of directory 100. Specifically, client station 14A parses the portion of the XML string corresponding to branch folder 111, branch folders 121, 122, and 123, and files 226 and 227 in data directory 100. As shown in FIG. 2, branch folders 121, 122, and 123, and files 226 and 227 are descendents of folder 111 in the tree structure of directory 100.

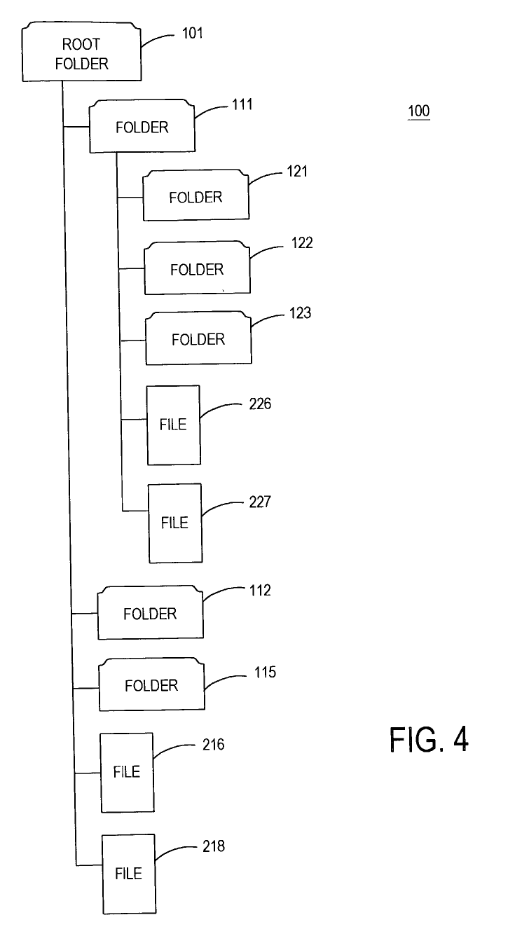

In response to parsing the portions of the XML string, client station 14A, in a step 314, generate codes, e.g., JavaScript codes, to present the subtree structure from root folder 101 to one level under the branch folder, e.g., branch folder 111, clicked by the user. FIG. 4 illustrates a presentation of directory 100 in response to the user seeking to access branch folder 111 in directory 100.

In accordance with the present invention, parsing the XML string and generating the codes to represent the tree structure of directory 100 can be performed regardless of whether client station 14A is in connection with network server 12 or not. In response to a user request, client station 14A only parses a portion of the XML string to generate the codes for the presentation of a portion of directory 100 that is directly below the folder selected by the user. This parse-only-on-demand step of data management process 300 is resource and time efficient.

In response to the user selecting to access a file in directory 100, e.g., file 246 in branch folder 131 of directory 100, client station 14A initiates a process of transferring the content of the file from network server 12 to client station 14A. In accordance with an embodiment of the present invention, client station 14A verifies the user request before starting the process of transferring the requested file. For example, client station 14A may ask the user to confirm the request for the file before starting the process of transferring the file. Transferring the file may include client station 14A establishing a connection with network server 12, downloading the content of the file from network server 12, and terminating the connection with network server 12. After the file is transferred to client station 14A, the user may access the file in various ways such as, for example, viewing the file, editing and modifying the file, renaming the file, duplicating the file, moving the file, deleting the file, etc.

By now it should be appreciated that a process for transferring and managing data in a network system has been provided. In accordance with the present invention, a data transfer and management process transfers only the tree structure of a directory from a network server to a client station in response to a request at the client station for accessing the directory. The transferred tree structure of the directory is parsed on demand only. The parsing of the tree structure can be performed at the client station without the client station being connected to the network server and, therefore, without incurring the overhead of transferring data associated with establishing connections between the network server and the client station. Thus, the data transfer and management process in accordance with the present invention significantly improves the efficiency of utilizing the network resources and reduces the required connection time between the client station and the network server. The content of a file in a directory is transferred from the network server only when the user seeks to access the file itself. By reducing the times and duration of connection required for a data transfer, the data transfer and management process of the present invention improves both the efficiency and reliability of transferring data in a network system. It also improves the efficiency of utilizing the memory resource on the client station. By parsing the directory on demand, the data transfer and management process of the present invention provides easy and fast access to data.

While various embodiments of the present invention have been described with reference to the drawings, these are not intended to limit the scope of the present invention, which is set forth in the appending claims. Various modifications of the above described embodiments can be made by those skilled in the art after browsing the specification of the subject application. These modifications are within the scope and true spirit of the present invention. For example, the data transfer process is not limited to transferring an XML string representing the tree structure of a directory. Strings in other languages can be used to represent the tree structure of a directory and can transferred in a network. In addition, the tree structure is not limited to being presented with JavaScript codes.

1. A method for managing data, comprising the steps of:
transferring a string representing a tree structure of a directory from a server to a client station in response to a request at the client station for accessing the directory;
parsing a portion of the string in response to a request for accessing a folder in the directory; and
generating a code presenting a descendent of the folder in the tree structure of the directory.

2. The method of claim 1, further comprising the step of establishing a connection between the client station and the server in response to the request at the client station for accessing the directory.

3. The method of claim 1, further comprising the step of terminating the connection between the client station and the server after transferring the string representing the tree structure of the directory from the server to the client station.

4. The method of claim 1, wherein the step of transferring a string representing a tree structure of a directory includes transferring a string for a root folder and a name of at least one file in the directory from the server to the client station.

5. The method of claim 4, wherein the step of transferring a string representing a tree structure of a directory further includes transferring the string for a branch folder in the directory.

6. The method of claim 1, wherein the step of transferring a string representing a tree structure of a directory includes transferring an Extensible Markup Language (XML) string for a root folder, all branch folders, and a list of all files in the directory from the server to the client station.

7. The method of claim 6, wherein the step of parsing a portion of the string includes parsing a portion of the XML string for direct descendents of the folder in response to the request for accessing the folder in the directory.

8. The method of claim 7, wherein the step of generating a code includes generating a JavaScript code presenting the direct descendents of the folder.

9. The method of claim 1, further comprising the step of, in response to a request at the client station for accessing a file in the directory, transferring the file from the server to the client station.

10. The method of claim 9, further comprising the steps of:
establishing a connection between the client station and the server in response to the request for accessing the file in the directory;
transferring a content of the file from the server to the client station; and
terminating the connection after transferring the content of the file from the server to the client station.

11. A data transfer and management process, comprising the steps of:
establishing a connection between a first station and a second station in response to a request at the first station for accessing a directory on the second station;
transferring a string representing a tree structure of the directory from the second station to the first station;
storing the string in the first station;
parsing a portion of the string in response to a request for accessing a folder in the directory; and
generating a code presenting a descendent of the folder in the tree structure of the directory.

12. The data transfer and management process of claim 11, wherein the step of transferring a string representing a tree structure of a directory from the second station to the first station includes transferring an Extensible Markup Language (XML) string for a root folder and all descendents of the root folder in the directory.

13. The data transfer and management process of claim 11, wherein the step of parsing a portion of the string in response to a request for accessing a folder in the directory includes parsing the portion of the string regarding direct descendents of the folder.

14. The data transfer and management process of claim 11, wherein the step of generating a code includes generating a JavaScript code presenting the direct descendents of the folder in the directory.

15. The data transfer and management process of claim 11, further comprising the step of, in response to a request at the first station for accessing a file in the directory, transferring the file from the second station to the first station.

16. A readable medium accessible by a processor in a computer, said readable medium including a program for performing a process comprising the steps of:
transferring an Extensible Markup Language (XML) string representing a tree structure of a directory from a server to the computer in response to a request for accessing the directory; and
generating a JavaScript code from the XML string presenting a descendent of a folder in the tree structure of the directory in response to a request for accessing the folder in the directory.

17. The readable medium of claim 16, wherein the step of transferring an XML string includes transferring the XML string for a root folder, all branch folders, and all file names in the directory.

18. The readable medium of claim 16, wherein the step of generating a JavaScript code includes parsing a portion of the XML string for all direct descendents of the folder in response to the request for accessing the folder in the directory.

19. The readable medium of claim 16, wherein the process further comprises the step of, in response to a request for accessing a file in the directory, transferring the file from the server to the computer.

20. The readable medium of claim 16, wherein the process further comprises the steps of
establishing a connection between the computer and the server in response to the request for accessing the directory; and
terminating the connection between the computer and the server after transferring the string representing the tree structure of the directory from the server to the computer.
